(19) United States
(12) Patent Application Publication
(10) Pub. No.: US 2016/0055613 A1
(43) Pub. Date: Feb. 25, 2016

(54) Image Processing Method, Virtual Machine, and Virtual Machine System

(71) Applicant: Huawei Technologies Co., Ltd., Shenzhen (CN)

(72) Inventor: Chuyue Ai, Shenzhen (CN)

(21) Appl. No.: 14/928,654

(22) Filed: Oct. 30, 2015

Related U.S. Application Data
(63) Continuation of application No. PCT/CN2014/073373, filed on Mar. 13, 2014.

(51) Int. Cl. G06T 1/20; G06T 15/00; G06F 3/14; G06T 11/00

(52) U.S. Cl. CPC G06T 1/20; G06T 11/00; G06T 15/005; G06F 3/14

(57) ABSTRACT

An image processing method, a virtual machine, and a virtual machine system, which improve reliability and a fault recovery capability of a GPU shared system. The solution includes sending, by a graphics driver of a virtual machine, a graphics processing instruction to a shared rendering server, so that the shared rendering server performs 3D graphics rendering according to the graphics processing instruction, monitoring, by a display server, a status of the shared rendering server, when determining that the shared rendering server is faulty, sending, by the display server, an indication message to the graphics driver, so that the graphics driver switches from a 3D working mode to a 2D working mode according to the indication message, and performing, by the virtual machine, 2D graphics rendering on a subsequent graphics processing instruction by using a local rendering server to obtain 2D image data.

### CROSS-REFERENCE TO RELATED APPLICATIONS

This application is a continuation of International Application No. PCT/CN2014/073373, filed on Mar. 13, 2014, which is hereby incorporated by reference in its entirety.

### TECHNICAL FIELD

The present disclosure relates to the field of computers, and in particular, to an image processing method, a virtual machine, and a virtual machine system.

### BACKGROUND

Graphics Processing Unit (GPU) shared virtual machine systems often apply a GPU virtualization technology. Using the GPU virtualization technology, a virtual machine instance running on a data center server can share one or more GPUs to perform a graphic operation. Such a desktop access manner is secure and highly-efficient, and has been increasingly popular with users.

When logging in to a remote desktop, a user may use some three-dimensional software that relies on a GPU to perform a graphic operation, such as Auto Computer Aided Design (AutoCAD), 3D Studio Max (3Ds Max), and Pro/Engineer. When the software runs on a virtual machine, a GPU virtualization technology may be used. As shown in FIG. 1, which is a schematic diagram of an overall structure of GPU virtualization, on a virtual machine (Guest operating system (OS)), a three-dimensional (3D) graphics driver module may include a Windows Display Driver Model ((WWDM), a new-generation graphics driver program model of Microsoft®) kernel-mode driver or an Open Graphics Library ((OpenGL), a graphics program interface) driver to obtain 3D graphics instructions of various types of 3D software and an operating system and two-dimensional (2D) Graphics Device Interface (GDI) instructions of an operating system. The 3D graphics driver module sends these instructions to a shared rendering server, and a physical GPU is invoked on the shared rendering server to perform instruction rendering, form a final desktop image of the virtual machine, and send the final desktop image to the virtual machine of the user. After a process such as video stream compression on the obtained final desktop image of the virtual machine, the virtual machine sends, by using a network, the final desktop image to a client for display.

However, because rendering and video stream compression on the final desktop image of the virtual machine are performed on the shared rendering server, if the shared rendering server is faulty or restarted when the user is using the virtual machine, the user cannot continue to view the desktop image of the virtual machine and cannot save related work that is uncompleted.

### SUMMARY

Embodiments of the present disclosure provide an image processing method, a virtual machine, and a virtual machine system, where a local rendering server is added to the virtual machine, so that by using a monitoring mechanism of a display server, 2D image processing is transferred seamlessly to the virtual machine for performing when a shared rendering server is faulty, which improves reliability and a fault recovery capability of a GPU shared system.

To achieve the foregoing objective, the embodiments of the present disclosure use the following technical solutions According to a first aspect, an embodiment of the present disclosure provides an image processing method, applied to a virtual machine system, where the virtual machine system includes a virtual machine and a shared rendering server, the virtual machine includes a display server, a graphics driver, and a local rendering server, and the method includes sending, by the graphics driver of the virtual machine, a graphics processing instruction to the shared rendering server, so that the shared rendering server performs 3D graphics rendering according to the graphics processing instruction, monitoring, by the display server, a status of the shared rendering server, when determining that the shared rendering server is faulty, sending, by the display server, an indication message to the graphics driver, so that the graphics driver switches from a 3D working mode to a 2D working mode according to the indication message, and performing, by the virtual machine, 2D graphics rendering on a subsequent graphics processing instruction by using the local rendering server to obtain 2D image data.

In a first possible implementation manner of the first aspect, the display server establishes a heartbeat connection to the shared rendering server, where the monitoring, by the display server, a status of the shared rendering server includes determining, by the display server, whether heartbeat report information of the shared rendering server is received within preset time.

With reference to the first aspect and the first possible implementation manner of the first aspect, in a second possible implementation manner of the first aspect, before the sending, by the display server, an indication message to the graphics driver, the method further includes closing, by the display server, an Authentic, Energetic, Reflective, and Open (AERO) user interface of an operating system of the virtual machine.

With reference to the first aspect and the first to second possible implementation manners of the first aspect, in a third possible implementation manner of the first aspect, that the graphics driver switches from a 3D working mode to a 2D working mode according to the indication message includes stopping, by the graphics driver, sending a graphics processing instruction to the shared rendering server, and invoking the local rendering server to perform 2D graphics rendering.

With reference to the first aspect and the first to third possible implementation manners of the first aspect, in a fourth possible implementation manner of the first aspect, after the sending an indication message to the graphics driver, the method further includes breaking, by the display server, the connection to the shared rendering server.

With reference to the first aspect and the first to fourth possible implementation manners of the first aspect, in a fifth possible implementation manner of the first aspect, the display server sends the indication message to the graphics driver by using a DirectX Graphics Infrastructure (DXGI) interface.

According to a second aspect, an embodiment of the present disclosure provides a virtual machine, applied to a virtual machine system, where the virtual machine system includes the virtual machine and a shared rendering server, and the virtual machine includes a display server, a graphics driver, and a local rendering server, where the display server is configured to monitor a status of the shared rendering server; and when determining that the shared rendering server is faulty, send an indication message to the graphics driver, so that the graphics driver switches from a 3D working mode to a 2D working mode according to the indication message, the graphics driver is configured to send a graphics processing instruction to the shared rendering server, so that the shared rendering server performs 3D graphics rendering according to the graphics processing instruction, and the local rendering server is configured to perform 2D graphics rendering on a subsequent graphics processing instruction to obtain 2D image data.

In a first possible implementation manner of the second aspect, the display server is further configured to establish a heartbeat connection to the shared rendering server, and determine whether heartbeat report information of the shared rendering server is received within preset time.

With reference to the second aspect and the first possible implementation manner of the second aspect, in a second possible implementation manner of the second aspect, the display server is further configured to close an AERO user interface of an operating system of the virtual machine.

With reference to the second aspect and the first to second possible implementation manners of the second aspect, in a third possible implementation manner of the second aspect, the graphics driver is configured to stop sending a graphics processing instruction to the shared rendering server, and invoke the local rendering server to perform 2D graphics rendering.

With reference to the second aspect and the first to third possible implementation manners of the second aspect, in a fourth possible implementation manner of the second aspect, the display server is further configured to break the connection to the shared rendering server.

With reference to the second aspect and the first to fourth possible implementation manners of the second aspect, in a fifth possible implementation manner of the second aspect, the display server sends the indication message to the graphics driver by using a DXGI interface.

According to a third aspect, an embodiment of the present disclosure provides a virtual machine, applied to a virtual machine system, where the virtual machine system includes the virtual machine and a shared rendering server, and the virtual machine includes a sending unit configured to send, by a graphics driver of the virtual machine, a graphics processing instruction to the shared rendering server, so that the shared rendering server performs 3D graphics rendering according to the graphics processing instruction, a monitoring unit configured to monitor, by a display server, a status of the shared rendering server, a switching unit configured to, when the display server determines that the shared rendering server is faulty, send an indication message to the graphics driver, so that the graphics driver switches from a 3D working mode to a 2D working mode according to the indication message, and a processing unit configured to perform, by the virtual machine, 2D graphics rendering on a subsequent graphics processing instruction by using a local rendering server to obtain 2D image data.

In a first possible implementation manner of the third aspect, the monitoring unit is configured to establish, by the display server, a heartbeat connection to the shared rendering server, and determine, by the display server, whether heartbeat report information of the shared rendering server is received within preset time.

With reference to the third aspect and the first possible implementation manner of the third aspect, in a second possible implementation manner of the third aspect, the switching unit is further configured to stop, by the graphics driver, sending a graphics processing instruction to the shared rendering server, and invoke the local rendering server to perform 2D graphics rendering; close, by the display server, an AERO user interface of an operating system of the virtual machine; and break, by the display server, the connection to the shared rendering server.

According to a fourth aspect, an embodiment of the present disclosure provides a virtual machine system, where the virtual machine system includes a virtual machine and a shared rendering server, the virtual machine includes a display server, a graphics driver, and a local rendering server, the virtual machine is configured to send a graphics processing instruction to a graphics processing unit, so that the shared rendering server performs 3D graphics rendering according to the graphics processing instruction; monitor a status of the shared rendering server; when it is determined that the shared rendering server is faulty, send an indication message to the graphics driver, so that the graphics driver switches from a 3D working mode to a 2D working mode according to the indication message; and perform 2D graphics rendering on a subsequent graphics processing instruction by using the local rendering server to obtain 2D image data, and the shared rendering server is configured to periodically send heartbeat report information to the virtual machine, so that the display server determines whether the shared rendering server is faulty.

The embodiments of the present disclosure provide an image processing method, a virtual machine, and a virtual machine system, where a local rendering server is added to a virtual machine. By using a monitoring mechanism of a display server, a fault is perceived in time when a shared rendering server cannot work normally and 2D image processing is transferred to the local rendering server of the virtual machine for performing, so that the virtual machine can perform an operation such as saving uncompleted work, which improves reliability and a fault recovery capability of a GPU shared system, and provides an emergency virtual machine operating manner for a user.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic architectural diagram of a GPU shared virtual machine system according to an embodiment of the present disclosure.

FIG. 2 is schematic flowchart 1 of an image processing method according to an embodiment of the present disclosure.

FIG. 3 is a schematic architectural diagram of a GPU shared virtual machine system according to an embodiment of the present disclosure.

FIG. 4 is schematic flowchart 2 of an image processing method according to an embodiment of the present disclosure.

FIG. 5 is a schematic structural diagram of a virtual machine system according to an embodiment of the present disclosure.

FIG. 6 is schematic structural diagram 1 of a virtual machine according to an embodiment of the present disclosure.

FIG. 7 is schematic structural diagram 2 of a virtual machine according to an embodiment of the present disclosure.

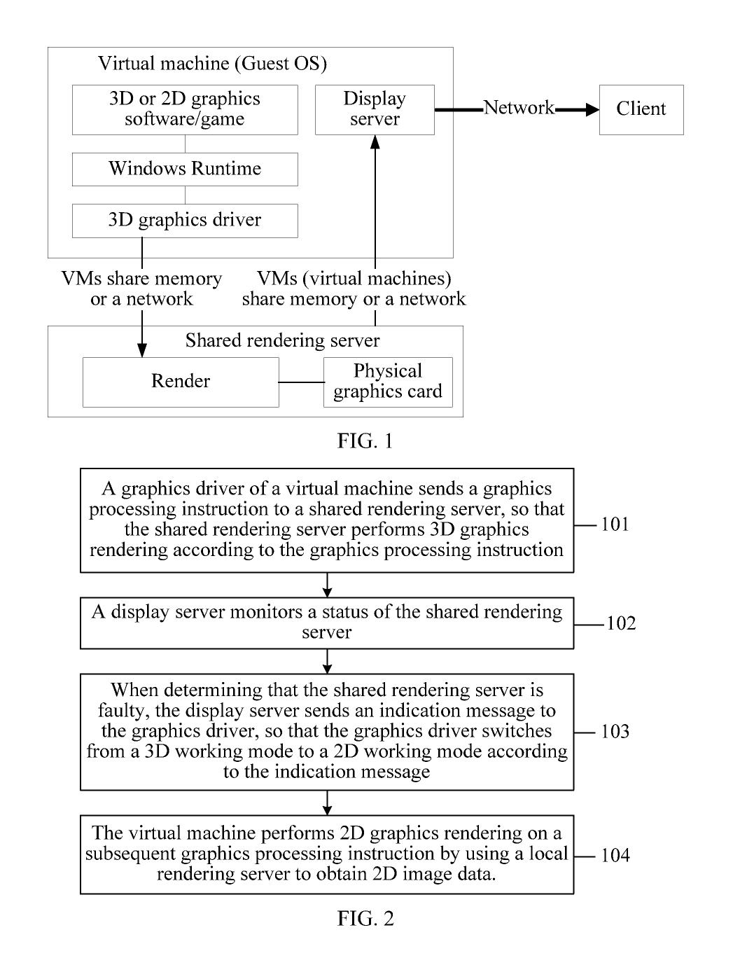

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

### Embodiment 1

This embodiment of the present disclosure provides an image processing method, as shown in FIG. 2, including 101: A graphics driver of a virtual machine sends a graphics processing instruction to a shared rendering server, so that the shared rendering server performs 3D graphics rendering according to the graphics processing instruction.

This embodiment of the present disclosure provides an image processing method, where by adding a local rendering server to a virtual machine, the virtual machine transfers 2D image processing to the local rendering server of the virtual machine for performing when a shared rendering server outside the virtual machine cannot work normally and a fault message is reported, so that the virtual machine can perform an operation such as saving uncompleted work, which improves reliability and a fault recovery capability of a GPU shared system and provides an emergency virtual machine operating manner for a user.

The shared rendering server refers to a computer cluster that is formed by connecting a group of computers according to a communications protocol, where the group of computers allows workload to be migrated from an overloaded computer to another computer in the cluster, and such a feature is referred to as load balancing. The shared rendering server aims to process a 3D instruction sent from each virtual machine to improve a rendering capability for 3D graphics.

On a virtual machine (Guest OS), 3D graphics instructions and 2D graphics instructions of various types of 3D software and an operating system are obtained by using a graphics driver. The graphics driver sends these instructions to the shared rendering server, a physical GPU is invoked on the shared rendering server to perform instruction rendering and form a final desktop image of the virtual machine, and then after a process such as video stream compression on the obtained final desktop image of the virtual machine, the virtual machine sends the final desktop image to a client for display.

102: A display server monitors a status of the shared rendering server.

In an entire process in which the graphics driver of the virtual machine sends the graphics processing instruction to the shared rendering server so that the shared rendering server performs 3D graphics rendering according to the graphics processing instruction, the display server monitors the shared rendering server in real time to obtain working status information of the shared rendering server.

Further, the display server may use a heartbeat report mechanism to monitor the shared rendering server in real time. The display server determines whether heartbeat report information of the shared rendering server is received within preset time. If no heartbeat report information of the shared rendering server is received within the preset time, the display server determines that the shared rendering server is faulty, and then sends an indication message to the graphics driver, so that the graphics driver switches from a 3D working mode to a 2D working mode according to the indication message.

The heartbeat report information refers to feedback data in a heartbeat mechanism inside a virtual machine or a computer. The heartbeat report information may also be referred to as a heartbeat packet, that is, a transmit end regularly sends simple information to a receive end to inform the receive end that the transmit end is still in a normal connection state. The simple information may be a piece of fixed information that is sent to the receive end every few minutes. After receiving the simple information, a receive end replies with a piece of fixed information. If the receive end receives no information from the transmit end within a few minutes, it may be regarded that disconnection occurs. For example, to learn whether communications software that has not been used for a long time is in an online or offline state, a heartbeat packet is required, and packet sending and receiving needs to be performed regularly. The reason why a heartbeat packet is referred to as a heartbeat packet is that the heartbeat packet is sent at a fixed interval like a heartbeat, so as to inform the receive end that the transmit end is still alive. In fact, this is for maintaining a long connection. Content of the packet is not particularly stipulated except that the packet is generally a very small packet, or the packet is a null packet that includes only a packet header.

103: When determining that the shared rendering server is faulty, the display server sends an indication message to the graphics driver, so that the graphics driver switches from a 3D working mode to a 2D working mode according to the indication message.

If the display server receives no heartbeat report information of the shared rendering server within the preset time, the display server determines that the shared rendering server is faulty, and in this case, the display server sends the indication message to the graphics driver, so that the graphics driver stops sending a graphics processing instruction to the shared rendering server, and invokes the local rendering server to perform 2D graphics rendering.

In addition, after the display server sends the indication message to the graphics driver, the display server breaks the connection to the shared rendering server, and prepares to receive 2D graphics processed by the local rendering server.

Further, before the display server sends the indication message to the graphics driver, if the operating system of the virtual machine is running an AERO user interface, the display server closes the AERO user interface of the operating system of the virtual machine. Because AERO effects are completely rendered by a 3D instruction, if AERO effects are not disabled, the virtual machine cannot use a local central processing unit (CPU) to process a graphics processing instruction that has been sent by the graphics driver.

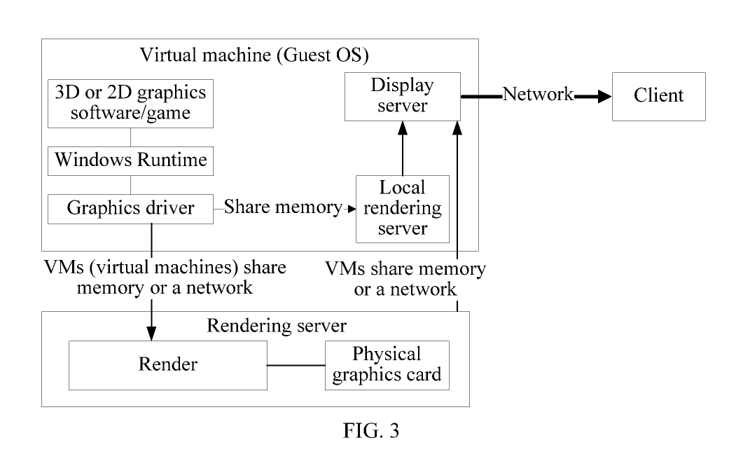

Exemplarily, as shown in FIG. 3, when user graphics software performs a 3D draw call by using a Windows interface, Windows Runtime ((WinRT), which is a cross-platform application program architecture in Windows 8) continues to call downward a corresponding instruction processing function registered with the graphics driver, and in this case, a thread of executing the call enters a specific instruction processing function. In a case in which the shared rendering server runs normally, these graphics instructions are sent to the shared rendering server and finally processed on a physical graphics card, and data returned to the virtual machine is a data packet that is based on a display protocol and has been compressed.

However, when a fault occurs on the shared rendering server, for example, a case occurs such as process suspension, abnormal exit, or loss of a graphics card, the display server first perceives the fault of the shared rendering server by using a heartbeat mechanism and instructs an image driver not to send new instruction data. In this case, a working mode of the graphics driver is switched, and 2D image processing is performed by using a Windows built-in graphics interface. A processed 2D image is sent to the local rendering server, actions such as video compression similar to that performed on the rendering server and data packet generation continue to be performed, and finally a data packet based on a display protocol is generated and sent to a client.

It should be noted that here the display server may send the indication message to the graphics driver by using a Windows built-in DXGI interface, so that the graphics driver performs, by using a local built-in graphics interface, 2D image processing on a 2D image instruction of instructions that have been sent to the rendering server.

So far, the display server learns the fault message of the shared rendering server and starts a local rendering mode, so that the graphics driver switches from a 3D working mode to a 2D working mode according to the indication message, and continues to execute the graphics processing instruction.

104: The virtual machine performs 2D graphics rendering on a subsequent graphics processing instruction by using a local rendering server to obtain 2D image data.

After the display server sends the indication message to the graphics driver, the graphics driver stops sending an instruction to the shared rendering server, and the graphics driver transfers a subsequent graphics processing instruction to a CPU for local processing to generate a 2D image, and sends the 2D image to the local rendering server. In this case, the local rendering server receives the 2D image sent from the graphics driver, and performs coding and compression on the 2D image sent by the graphics driver; finally, the local rendering server generates a data packet according to the coded and compressed 2D image and sends the data packet to the display server, so that the display server receives a data packet based on a display protocol from the local rendering server and sends the data packet that is based on a display protocol to a client.

So far, by adding a local rendering server to a virtual machine, 2D image processing is transferred seamlessly to the virtual machine for performing when a shared rendering server is faulty, which improves reliability and a fault recovery capability of a GPU shared system.

This embodiment of the present disclosure provides an image processing method, where a display server of a virtual machine sends a graphics processing instruction to a graphics processing unit, so that a shared rendering server of the graphics processing unit performs 3D graphics rendering according to the graphics processing instruction; the display server monitors a status of the shared rendering server; when determining that the shared rendering server is faulty, the display server sends an indication message to a graphics driver, so that the graphics driver switches from a 3D working mode to a 2D working mode according to the indication message; and the virtual machine performs 2D graphics rendering on a subsequent graphics processing instruction by using a local rendering server to obtain 2D image data. In the solution, the local rendering server is added to the virtual machine, and by using a monitoring mechanism of the display server, a fault is perceived in time when the shared rendering server cannot work normally and 2D image processing is transferred to the local rendering server of the virtual machine for performing, so that the virtual machine can perform an operation such as saving uncompleted work, which improves reliability and a fault recovery capability of a GPU shared system and provides an emergency virtual machine operating manner for a user.

### Embodiment 2

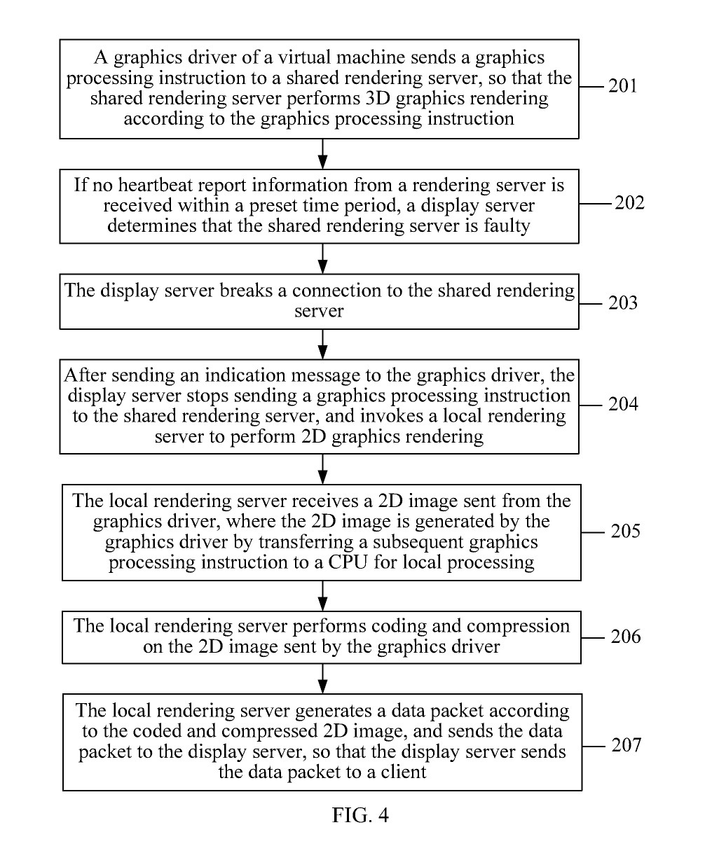

This embodiment of the present disclosure provides an image processing method, as shown in FIG. 4, including 201: A graphics driver of a virtual machine sends a graphics processing instruction to a shared rendering server, so that the shared rendering server performs 3D graphics rendering according to the graphics processing instruction.

This embodiment of the present disclosure provides an image processing method, where by adding a local rendering server to a virtual machine, the virtual machine transfers 2D image processing to the local rendering server of the virtual machine for performing when a shared rendering server outside the virtual machine cannot work normally and a fault message is reported, so that the virtual machine can perform an operation such as saving uncompleted work, which improves reliability and a fault recovery capability of a GPU shared system and provides an emergency virtual machine operating manner for a user.

As shown in FIG. 3, when user graphics software performs a 3D draw call by using a Windows interface, WinRT, which is a cross-platform application program architecture in Windows 8, continues to call downward a corresponding instruction processing function registered with the graphics driver, and in this case, a thread of executing the call enters a specific instruction processing function. In a case in which the shared rendering server runs normally, these graphics instructions are sent to the shared rendering server and finally processed on a physical graphics card, and data returned to the virtual machine is a data packet that is based on a display protocol and has been compressed.

However, when a fault occurs on the shared rendering server, for example, a case occurs such as process suspension, abnormal exit, or loss of a graphics card, the display server first perceives the fault of the shared rendering server by using a heartbeat mechanism and instructs an image driver not to send new instruction data. In this case, a working mode of the graphics driver is switched, and 2D image processing is performed by using a Windows built-in graphics interface. A processed 2D image is sent to the local rendering server, actions such as video compression similar to that performed on the rendering server and data packet generation continue to be performed, and finally a data packet based on a display protocol is generated and sent to a client.

202: If no heartbeat report information from a rendering server is received within a preset time period, a display server determines that the shared rendering server is faulty.

In an entire process in which the graphics driver of the virtual machine sends the graphics processing instruction to the shared rendering server so that the shared rendering server performs 3D graphics rendering according to the graphics processing instruction, the display server monitors the shared rendering server in real time to obtain working status information of the shared rendering server.

Further, the display server may use a heartbeat report mechanism to monitor the shared rendering server in real time. The display server determines whether heartbeat report information of the shared rendering server is received within the preset time. If no heartbeat report information of the shared rendering server is received within the preset time, the display server determines that the shared rendering server is faulty, and then sends an indication message to the graphics driver, so that the graphics driver switches from a 3D working mode to a 2D working mode according to the indication message.

203: The display server breaks a connection to the shared rendering server.

After the display server sends the indication message to the graphics driver, the display server breaks the connection to the shared rendering server, and prepares to receive 2D graphics processed by the local rendering server.

204: After sending an indication message to the graphics driver, the display server stops sending a graphics processing instruction to the shared rendering server, and invokes a local rendering server to perform 2D graphics rendering.

If the display server receives no heartbeat report information of the shared rendering server within the preset time, the display server determines that the shared rendering server is faulty, and in this case, the display server sends the indication message to the graphics driver, so that the graphics driver switches from a 3D working mode to a 2D working mode. In this case, the graphics driver stops sending a graphics processing instruction to the shared rendering server, and invokes the local rendering server to perform 2D graphics rendering.

Further, before the display server sends the indication message to the graphics driver, if an operating system of the virtual machine is running an AERO user interface, the display server closes the AERO user interface of the operating system of the virtual machine. Because AERO effects are completely rendered by a 3D instruction, if AERO effects are not disabled, the virtual machine cannot use a local CPU to process a graphics processing instruction that has been sent by the graphics driver.

It should be noted that here the display server may send the indication message to the graphics driver by using a Windows built-in DXGI interface, so that the graphics driver performs, by using a local built-in graphics interface, 2D image processing on a 2D image instruction of instructions that have been sent to the rendering server.

205: The local rendering server receives a 2D image sent from the graphics driver, where the 2D image is generated by the graphics driver by transferring a subsequent graphics processing instruction to a CPU for local processing.

After the display server sends the indication message to the graphics driver, the graphics driver stops sending an instruction to the rendering server, and the graphics driver transfers a subsequent graphics processing instruction to a CPU for local processing to generate a 2D image, and sends the 2D image to the local rendering server.

206: The local rendering server performs coding and compression on the 2D image sent by the graphics driver.

Image coding refers to transformation, encoding, and compression that are performed on image data when a requirement of fidelity is met, so that redundant data is removed to reduce a data amount required for representing a digital image, so as to facilitate storage and transmission of an image. That is, the image coding is a technology of using a smaller data amount to represent an original pixel matrix in a lossy or lossless manner.

Image compression and coding may be classified into two types: one type of compression is reversible, that is, an original image can be entirely restored from compressed data and no information is lost, which is referred to as lossless compression and coding; the other type of compression is irreversible, that is, an original image cannot be entirely restored from compressed data, and some information is lost, which is referred to as lossy compression and coding. This embodiment of the present disclosure does not impose a limitation thereto, and there may be multiple possibilities according to specific settings in a virtual machine.

After receiving the 2D image sent from the graphics driver, the local rendering server carries out work such as performing, by using a CPU of the virtual machine, coding and compression on the 2D image sent by the graphics driver and organizing a data packet, and finally generates a data packet that is based on a display protocol. It should be noted that, compared with the shared rendering server, the local rendering server can process only a 2D image instruction or perform only 2D image compression, and cannot process a 3D image instruction or perform 3D image compression.

207: The local rendering server generates a data packet according to the coded and compressed 2D image, and sends the data packet to the display server, so that the display server sends the data packet to a client.

The local rendering server generates a data packet according to the coded and compressed 2D image, and sends the data packet to the display server, so that the display server receives a data packet that is based on a display protocol from the local rendering server, and sends the data packet based on a display protocol to the client.

Exemplarily, a user uses a client to perform remote desktop control on a personal computer (PC) of the user; if process suspension occurs on a rendering server when the user modifies a word document by means of remote desktop control, a virtual machine of the user can discover a fault on the rendering server in time by using a heartbeat mechanism, and start a local rendering server to draw a PC desktop of the virtual machine, so that without changing an interface protocol, the following phenomenon is avoided: user data is lost because the word document cannot be saved in time due to the process suspension on the rendering server.

So far, by adding a local rendering server to a virtual machine, 2D image processing is transferred seamlessly to the virtual machine for performing when a rendering server is faulty, which improves reliability and a fault recovery capability of a GPU shared system.

This embodiment of the present disclosure provides an image processing method, where a display server of a virtual machine sends a graphics processing instruction to a graphics processing unit, so that a shared rendering server of the graphics processing unit performs 3D graphics rendering according to the graphics processing instruction; the display server monitors a status of the shared rendering server; when determining that the shared rendering server is faulty, the display server sends an indication message to a graphics driver, so that the graphics driver switches from a 3D working mode to a 2D working mode according to the indication message; and the virtual machine performs 2D graphics rendering on a subsequent graphics processing instruction by using a local rendering server to obtain 2D image data. In the solution, the local rendering server is added to the virtual machine, and by using a monitoring mechanism of the display server, a fault is perceived in time when the shared rendering server cannot work normally and 2D image processing is transferred to the local rendering server of the virtual machine for performing, so that the virtual machine can perform an operation such as saving uncompleted work, which improves reliability and a fault recovery capability of a GPU shared system and provides an emergency virtual machine operating manner for a user.

### Embodiment 3

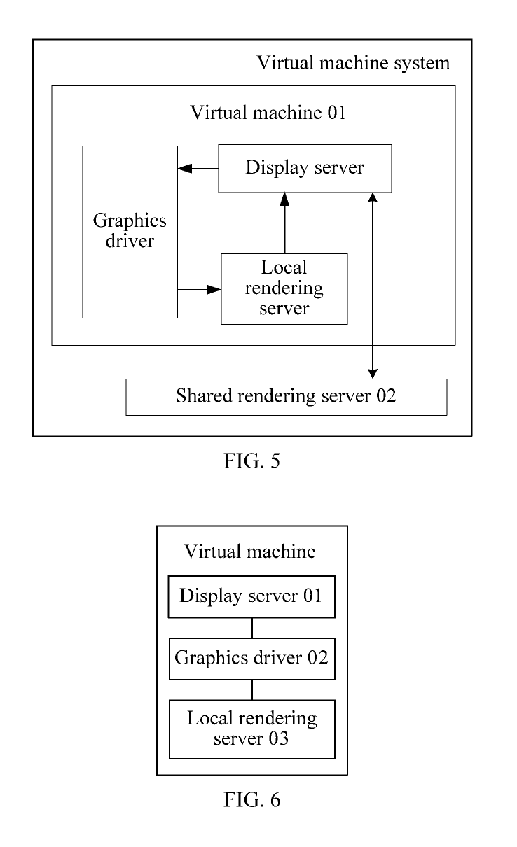

This embodiment of the present disclosure provides a virtual machine system, and as shown in FIG. 5, the virtual machine system includes a virtual machine 01 and a shared rendering server 02, where the virtual machine includes a display server, a graphics driver, and a local rendering server, where the virtual machine 01 is configured to send a graphics processing instruction to a graphics processing unit, so that a shared rendering server of the graphics processing unit performs 3D graphics rendering according to the graphics processing instruction; monitor a status of the shared rendering server; when it is determined that the shared rendering server is faulty, send an indication message to the graphics driver, so that the graphics driver switches from a 3D working mode to a 2D working mode according to the indication message; and perform 2D graphics rendering on a subsequent graphics processing instruction by using the local rendering server to obtain 2D image data, and the shared rendering server 02 is configured to periodically send heartbeat report information to the virtual machine, so that the display server determines whether the shared rendering server is faulty.

This embodiment of the present disclosure provides a virtual machine system, where a display server of a virtual machine sends a graphics processing instruction to a graphics processing unit, so that a shared rendering server of the graphics processing unit performs 3D graphics rendering according to the graphics processing instruction; the display server monitors a status of the shared rendering server; when determining that the shared rendering server is faulty, the display server sends an indication message to a graphics driver, so that the graphics driver switches from a 3D working mode to a 2D working mode according to the indication message; and the virtual machine performs 2D graphics rendering on a subsequent graphics processing instruction by using a local rendering server to obtain 2D image data. In the solution, the local rendering server is added to the virtual machine, and by using a monitoring mechanism of the display server, a fault is perceived in time when the shared rendering server cannot work normally and 2D image processing is transferred to the local rendering server of the virtual machine for performing, so that the virtual machine can perform an operation such as saving uncompleted work, which improves reliability and a fault recovery capability of a GPU shared system and provides an emergency virtual machine operating manner for a user.

### Embodiment 4

This embodiment of the present disclosure provides a virtual machine, as shown in FIG. 6. The virtual machine is applied to a virtual machine system, where the virtual machine system includes the virtual machine and a shared rendering server, and the virtual machine includes a display server 01, a graphics driver 02, and a local rendering server 03, where the display server 01 is configured to monitor a status of the shared rendering server; and when determining that the shared rendering server is faulty, send an indication message to the graphics driver 02, so that the graphics driver 02 switches from a 3D working mode to a 2D working mode according to the indication message, the graphics driver 02 is configured to send a graphics processing instruction to the shared rendering server, so that the shared rendering server performs 3D graphics rendering according to the graphics processing instruction, and the local rendering server 03 is configured to perform 2D graphics rendering on a subsequent graphics processing instruction to obtain 2D image data.

Further, the display server 01 is further configured to establish a heartbeat connection to the shared rendering server, and determine whether heartbeat report information of the shared rendering server is received within preset time.

Further, the display server 01 is further configured to close an AERO user interface of an operating system of the virtual machine.

Further, the graphics driver 02 is configured to stop sending a graphics processing instruction to the shared rendering server, and invoke the local rendering server 03 to perform 2D graphics rendering.

Further, the display server 01 is further configured to break the connection to the shared rendering server.

Further, the display server 01 sends the indication message to the graphics driver 02 by using a DXGI interface.

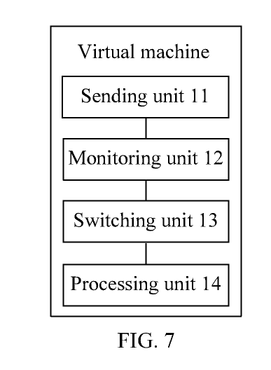

This embodiment of the present disclosure provides a virtual machine, as shown in FIG. 7. The virtual machine is applied to a virtual machine system, where the virtual machine system includes the virtual machine and a shared rendering server, and the virtual machine includes a sending unit 11 configured to send, by a graphics driver of the virtual machine, a graphics processing instruction to the shared rendering server, so that the shared rendering server performs 3D graphics rendering according to the graphics processing instruction, a monitoring unit 12 configured to monitor, by a display server, a status of the shared rendering server, a switching unit 13 configured to configured to when the display server determines that the shared rendering server is faulty, send an indication message to the graphics driver, so that the graphics driver switches from a 3D working mode to a 2D working mode according to the indication message, and a processing unit 14 configured to perform, by the virtual machine, 2D graphics rendering on a subsequent graphics processing instruction by using a local rendering server to obtain 2D image data.

Further, the monitoring unit 12 is configured to establish, by the display server, a heartbeat connection to the shared rendering server, and determine, by the display server, whether heartbeat report information of the shared rendering server is received within preset time.

Further, the switching unit 13 is further configured to stop, by the graphics driver, sending a graphics processing instruction to the shared rendering server, and invoke the local rendering server to perform 2D graphics rendering; close, by the display server, an AERO user interface of an operating system of the virtual machine; and break, by the display server, the connection to the shared rendering server.

This embodiment of the present disclosure provides a virtual machine, where a display server of the virtual machine sends a graphics processing instruction to a graphics processing unit, so that a shared rendering server of the graphics processing unit performs 3D graphics rendering according to the graphics processing instruction; the display server monitors a status of the shared rendering server; when determining that the shared rendering server is faulty, the display server sends an indication message to a graphics driver, so that the graphics driver switches from a 3D working mode to a 2D working mode according to the indication message; and the virtual machine performs 2D graphics rendering on a subsequent graphics processing instruction by using a local rendering server to obtain 2D image data. In the solution, the local rendering server is added to the virtual machine, and by using a monitoring mechanism of the display server, a fault is perceived in time when the shared rendering server cannot work normally and 2D image processing is transferred to the local rendering server of the virtual machine for performing, so that the virtual machine can perform an operation such as saving uncompleted work, which improves reliability and a fault recovery capability of a GPU shared system and provides an emergency virtual machine operating manner for a user.

It may be clearly understood by a person skilled in the art that, for the purpose of convenient and brief description, division of the foregoing function modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the, or all or some of the technical solutions may be implemented in the form of a software product. The software product is stored in a storage medium and includes several instructions for instructing a computer device (which may be a personal computer, a server, or a network device) or a processor to perform all or some of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An image processing method, applied to a virtual machine system, wherein the virtual machine system comprises a virtual machine and a shared rendering server, wherein the virtual machine comprises a display server, a graphics driver, and a local rendering server, and wherein the method comprises:
sending, by the graphics driver of the virtual machine, a graphics processing instruction to the shared rendering server, so that the shared rendering server performs three-dimensional (3D) graphics rendering according to the graphics processing instruction;
monitoring, by the display server, a status of the shared rendering server;
sending, by the display server, an indication message to the graphics driver when determining that the shared rendering server is faulty;
switching, by the graphics driver of the virtual machine, from a 3D working mode to a two-dimensional (2D) working mode according to the indication message; and
performing, by the virtual machine, 2D graphics rendering on a subsequent graphics processing instruction by using the local rendering server to obtain 2D image data.

2. The method according to claim 1, wherein the display server establishes a heartbeat connection to the shared rendering server, and wherein monitoring, by the display server, the status of the shared rendering server comprises determining, by the display server, whether heartbeat report information of the shared rendering server is received within preset time.

3. The method according to claim 1, wherein before sending, by the display server, the indication message to the graphics driver, the method further comprises closing, by the display server, an Authentic, Energetic, Reflective, and Open (AERO) user interface of an operating system of the virtual machine.

4. The method according to claim 1, wherein switching, by the graphics driver of the virtual machine, from the 3D working mode to the 2D working mode according to the indication message comprises:
stopping, by the graphics driver, sending a graphics processing instruction to the shared rendering server; and
invoking the local rendering server to perform 2D graphics rendering.

5. The method according to claim 1, wherein after sending the indication message to the graphics driver, the method further comprises breaking, by the display server, the heartbeat connection to the shared rendering server.

6. The method according to claim 1, wherein the display server sends the indication message to the graphics driver by using a DirectX Graphics Infrastructure (DXGI) interface.

7. A virtual machine system, wherein the virtual machine system comprises:
a shared rendering server; and
a virtual machine comprising a display server, a graphics driver, and a local rendering server,
wherein the display server is configured to:
monitor a status of the shared rendering server; and
send an indication message to the graphics driver when determining that the shared rendering server is faulty so that the graphics driver switches from a 3D working mode to a 2D working mode according to the indication message,
wherein the graphics driver is configured to send a graphics processing instruction to the shared rendering server so that the shared rendering server performs 3D graphics rendering according to the graphics processing instruction, and
wherein the local rendering server is configured to perform 2D graphics rendering on a subsequent graphics processing instruction to obtain 2D image data.

8. The virtual machine according to claim 7, wherein the display server is further configured to:
establish a heartbeat connection to the shared rendering server; and
determine whether heartbeat report information of the shared rendering server is received within preset time.

9. The virtual machine according to claim 7, wherein the display server is further configured to close an Authentic, Energetic, Reflective, and Open (AERO) user interface of an operating system of the virtual machine.

10. The virtual machine according to claim 7, wherein the graphics driver is further configured to:
stop sending the graphics processing instruction to the shared rendering server; and
invoke the local rendering server to perform 2D graphics rendering.

11. The virtual machine according to claim 8, wherein the display server is further configured to break the heartbeat connection to the shared rendering server.

12. The virtual machine according to claim 7, wherein the display server sends the indication message to the graphics driver by using a DirectX Graphics Infrastructure (DXGI) interface.

13. A virtual machine system, wherein the virtual machine system comprises:
a shared rendering server; and
a virtual machine comprising:
a sending unit configured to send a graphics processing instruction to the shared rendering server so that the shared rendering server performs 3D graphics rendering according to the graphics processing instruction;
a monitoring unit configured to monitor a status of the shared rendering server;
a switching unit configured to send an indication message to a graphics driver when the status of the shared rendering server is faulty so that the graphics driver switches from a 3D working mode to a 2D working mode according to the indication message; and
a processing unit configured to perform 2D graphics rendering on a subsequent graphics processing instruction by using a local rendering server to obtain 2D image data.

14. The virtual machine according to claim 13, wherein the monitoring unit is further configured to:
establish a heartbeat connection between a display server and the shared rendering server; and
determine whether heartbeat report information of the shared rendering server is received within preset time.

15. The virtual machine according to claim 13, wherein the switching unit is further configured to:
stop sending the graphics processing instruction to the shared rendering server;
invoke the local rendering server to perform 2D graphics rendering;
close an Authentic, Energetic, Reflective, and Open (AERO) user interface of an operating system of the virtual machine; and
break a heartbeat connection to the shared rendering server.

16. A virtual machine system, wherein the virtual machine system comprises:
a shared rendering server; and
a virtual machine comprising a display server, a graphics driver, and a local rendering server,
wherein the virtual machine is configured to:
send a graphics processing instruction to the shared rendering server so that the shared rendering server performs 3D graphics rendering according to the graphics processing instruction;
monitor a status of the shared rendering server;
send an indication message to the graphics driver when it is determined that the shared rendering server is faulty so that the graphics driver switches from a 3D working mode to a 2D working mode according to the indication message; and
perform 2D graphics rendering on a subsequent graphics processing instruction by using the local rendering server to obtain 2D image data, and
wherein the shared rendering server is configured to periodically send heartbeat report information to the virtual machine, so that the display server determines whether the shared rendering server is faulty.
